(19) United States
(12) Patent Application Publication
(10) Pub. No.: US 2018/0207793 A1
(43) Pub. Date: Jul. 26, 2018

(54) CRAWLING DEVICE AND THE METHOD OF DEPLOYMENT

(71) Applicant: Nanjing Yuanjue Information and Technology Company, NANJING (CN)

(72) Inventors: LIMING ZHENG, NANJING (CN); ZHENG ZHANG, NANJING (CN); TAO YU, NANJING (CN)

(73) Assignee: Nanjing Yuanjue Information and Technology Company, NANJING (CN)

(21) Appl. No.: 15/821,826

(22) Filed: Nov. 23, 2017

(30) Foreign Application Priority Data
Jan. 24, 2017 (CN) 201710060222.6

(51) Int. Cl. B25J 5/02; B25J 19/02

(52) U.S. Cl. CPC B25J 5/02; B25J 19/023

(57) ABSTRACT

A crawling device is used for surrounding a cylinder and crawling along the extension direction of the mentioned cylinder. The kind of crawling device may include at least two-nodes crawling modules, a telescopic mechanism, and a control circuit. The telescopic mechanism connects with two-nodes crawling modules, and the crawling modules have an elastic mechanism and a drawstring respectively. In creeping movement, the at least two-nodes crawling modules are set in turn that one crawling module as a fixed section and the other crawling module as a mobile section. When the crawling module is set as a fixed section, the crawling module adjusts the drawstring through the elastic mechanism to make the fixed section close to the cylinder. Producing friction by keeping close to the cylinder let the fixed section maintain the fixed state relatively close to the cylinder.

### TECHNICAL FIELD

The present invention is related to a crawling device and the method of deployment, and more particularly related to a wisdom crawling device and the deployment method.

### BACKGROUND

With the progress of electronic technology, there have been a variety different uses of robots or the machinery and equipment have been developed. Some machines do not need to be moved, for example, assembling in the factory, or performing surgery in the hospital. Some machines need to be moved to a specific location to serve the predetermined function. The most common way to move a machine is to use the wheels. However, in some special moving paths, such as uneven roads, areas full of obstacles or stairs, etc., the wheels are not an appropriate movable mechanism.

In particular, in the case of operating applications with vertical heights for various cylinders such as flagpoles, poles, cables, trunks, they are still dangerous or high-cost if using unmanned aerial vehicles or manpower. Therefore, the machine for moving the cylinders has great application requirements. In addition, if the machine may automatically adjust a variety of different cylinders, even avoid automatically obstacles on the cylinders; still be able to reach the specified position of the cylinder. The crawling device may bring great convenience and technical effect for a lot of operation.

### SUMMARY OF INVENTION

According to the embodiment of the present invention, the present invention provides a crawling device used for surrounding a cylinder and crawls along the extension direction of the mentioned cylinder. The kind of crawling device may include at least two-nodes crawling modules, a telescopic mechanism, and a control circuit.

The telescopic mechanism connects with two-nodes crawling modules, and the crawling modules have an elastic mechanism and a drawstring respectively. In the creeping movement, at least two-nodes crawling modules set one crawling module as a fixed section and the other crawling module as a mobile section in turn.

When the crawling module is set as a fixed section, the crawling module adjusts the drawstring through the elastic mechanism to make the fixed section close to the cylinder. Producing friction by keeping close to the cylinder let the fixed section maintain the fixed state relatively close to the cylinder.

When the crawling module is set as a mobile section, through the elastic mechanism adjusts the drawstring making the mobile section separate from the fixed state. And the relative position of the mobile and fixed section is adjusted through the telescopic mechanism to make the crawling device moving

In addition to providing vertical movement, in another embodiment, the crawling device may also be installed with a horizontal rotation mechanism for connecting with the two-nodes crawling modules. The two-nodes crawling modules adjust the relative angle of the relative cylinder through the horizontal rotation mechanism. For example, when one crawling device is fixed section and the other is mobile section, the movable section is rotated horizontally around the cylinder through the horizontal rotation mechanism. Besides, the two crawling modules are capable of being the fixed section and the mobile section alternately. Also, the crawling device may be positioned and relative to the cylinder at any angle of 360 degrees through multiple horizontally rotating. Of course, this is only a case of the embodiment, depending on the different technical requirements, such as the construction of the cylinder, the surface friction, the obstacle, the purpose of setting the crawling device, the weight of the carrying object, whether take the set angle into account, or cost considerations, etc., the designer may adjust the different configurations to achieve different purposes. All of these may still be considered to be within the scope of the invention, and not be limited by the embodiments provided below.

Moreover, about the functional setting of two or more crawling modules, these crawling modules are capable of being constructed in the same way and connected with each other through the telescopic mechanism.

On the other hand, these crawling modules may also be set as one of the secondary machines equipped with a functional device (such as a camera), the other one or more crawling modules are set as primary machines. The secondary machine is fixed to the cylinder after reaching the predetermined position and is disengaged from the primary machine. The primary machine using slow descent or secondary machine hanging rope in other ways to get down, then using the same way to get up. The primary machine may also design two-nodes crawling module. In this way, the secondary may be powered by the primary machine during the crawling process and fixed at the specified location to execute the task. In other words, the secondary machine may be simplified as much as possible to lower the manufacturing costs, and the same primary machine may be used to deploy multiple secondary machines. The primary machine may also does not need to have a complex waterproof or durable design for long-term use in bad weather depending on the cost consideration. The design is like a lunar module and the propellant rocket, and further enhances the technology and function of the overall crawling device.

For a crawling device, the crawling device is capable of having two or more crawling modules. The following detailed implementation and the accompanying illustration may further illustrate the example.

Furthermore, the cylinders are able to be telephone pole, street pillar, the columns of buildings or bridges and so on. Since the crawling device is used to adjust the circumference of encircled drawstring, so in a variety of tubular, rod, cable and other different cross-sectional shape, perimeter, material cylinder may use the same crawling device to crawl and deploy. Alternatively, the configuration of the crawling device may be adjusted by replacing the drawstring and other modularization way to be in response to various needs of the crawling deployment.

The cylinders may be tubular, solid and have a single cross-sectional perimeter shape, such as cylindrical column, elliptical column, square column, polygon column, or different cross sectional shape at different sections. The cylinders may be the up and straight column type of the electric pole, a square cylinder, and a column extension. The extension direction may be straight or non-linear. The column may be artificial or natural, such as trees or artificial stents.

The drawstring may be resilient or non-elastic. For example, drawstring may be soft material which is able to coil. Holding the drawstring open and bypassing the obstructions on the cylinder while the mobile device is moving which also include an open structure. The crawling module corresponds to one or two more of the drawstrings made of multiple connecting blocks similar to metal brackets, or made of plastic, rubber, cloth, textile, and so on. If the cylinder has a preset track, bump or groove, the cylinder is capable of configuring the corresponding drawstring.

Besides, the drawstring closes to the side of the cylinder may additionally increase the surface which increases friction, such as bumps, particles, streaks or grooves.

With the different extension directions of the cylinder, the crawling device is capable of moving up and down, but actually it also capable of moving horizontally, diagonally, and even annularly.

The control circuit and the corresponding control function may be set all or one part inside of the crawling device. One part of the function may be set outside of the crawling device. For example, part of the control functions is controlled by the external device, or in cooperation with the other crawling device or other external devices, or manually control, or switching between multiple control modes in accordance with predetermined conditions.

In addition, the control circuit may be a module, and mainly be installed in a crawling module. The control circuit may also be that each crawling module have a related circuit, and these circuits work together.

The control circuit may have computer vision operation to detect obstacles on the cylinder. The computer vision operation may compare crisscross or analyze the still images of the moving process to find the size and shape of the obstructions, and accordingly determine the way to bypass the obstructions. The computer vision operation may include various known computer vision identification software and/or hardware integration, such as all kinds of computer vision identification software or hardware in the use of unmanned vehicles. In addition, the computer vision operation here also may include a variety machine learning, such as using Support Vector Machine. Fuzzy Logic, neural network learning, Deep Learning, etc. to record and identify various obstacles on the cylinder through the feedback or non-feedback learning way. The areas and related technologies are able to be all integrated into the crawling device and are well known by those technicians of computer vision and machine learning. The concept may not be mentioned in details. Moreover, since the environment of the crawling cylinder is relatively simple, for instance, the images of the cylinder of each angle may be photographed in advance, and the comparation of the images in the process of the crawling device moving forward may help quickly determine the shape and size of the obstacles, and bypass or cross the obstacles according to the predetermined logic.

The crawling device may attach a camera. The camera may be connected with the control circuit of the crawling device. Otherwise, the camera may be a module to move to a predetermined position relative to the cylinder only through the carry of the crawling device. Alternatively, the camera may be powered by the crawling module.

The crawling device may be equipped with a battery to achieve a certain degree of mobility. Furthermore, the crawling device is also powered by the power supply circuit inside the cylinder after crawling to the proper position. Alternatively, the crawling device may set the operation mode for different power according to the internal battery power. For example, in order to let the staff replaces the battery or charge operation easier, the crawling device, which has been fixed to the top of the cylinder like pole, and automatically crawl to another location with a charging end height in advance, or automatically crawl to the bottom.

If the camera is installed, the camera may make crawling device in accordance with the images shoot whether the crawling device has reached the predetermined position or not through the hardware or software settings. For example, the crawling device is capable of placing a reference image of a predetermined size on the ground in advance, letting the camera shoot and convert, and then determining the altitude at that time. Moreover, a reference image of a predetermined size may be placed on the ground with the same technique. Depending on the calculation of the test image size and angle placed on the target location of the shooting, the crawling device may adjust and control the crawling device and make the crawling device to reach the appropriate location through the easy identification. The approach may be quickly deployed and aimed on the height and angle of the camera rather than through the complex manual computation or operation.

In addition to analyzing the image through the camera, crawling device may also automatically detect whether the crawling device has been crawled to the height and fixed at the set height by means of a height sensor or calculating crawled distance, for example, methods like calculating the number of turns through the wheel of the cylinder.

With respect to the angle, the crawling device may automatically adjust the angle of the crawling device by the direction detection sensor such as a compass. There are various directions of electronic or mechanical or micromechanical way that may be used to detect angles.

Besides, the crawling device may also set GPS and other positioning circuit. The control circuit may be based on the location of GPS, with reference to a previous specific height and angle of GPS location, and the operational model, to set the crawling device. The design method, for a large number of deployments of multiple crawling devices to a different location of one area, may have a lot of convenience. The operator only needs to carry multiple and identical crawling devices to a different position, and then let these crawling devices began to climb the corresponding poles and other columns. These crawling devices may accord with the predetermined parameters automatically to set up, and further work together. In other words, these crawling devices may form a crawling device network through the internet or other means to complete a complex job together.

It may be noted that in applications of multiple machines work and complete together, sometimes devices other than the crawling device, such as some devices that are set on the ground or in certain fixed positions are required. These devices may complete the work together via Bluetooth, Wi-Fi, 3G, 4G, 5G, Z-Wave, and other wired or wireless communication networks. Related operations may refer to the Internet of things and the relevant network programming concepts, and design for different applications. This concept may not be mentioned here in details.

In addition, in order to conserve power consumption, when the crawling device climbs to the predetermined position, the crawling device may lock the structure through the mechanic without using electric power to remain fixed in the relative position of cylinder. For example, the crawling device is capable of using the gear and other structures to tighten the drawstring through the power. The gear mechanical structure can maintain the state at that time in the absence of power. If moving the crawling mobile device is needed, then apply power, and then drive the gear to adjust the drawstring, such as relaxation or tension, and conduct the corresponding moving operation.

If the crawling device breaks down or loses power in high altitude, it may cast another crawling device and crawl next to the malfunction or loss of the crawling device; then the rescue crawling device may be used for replacing the parts and other repairing operations for the defective crawler device according to the different situations. Sometimes, if it is only because of software, rescue crawling device may also operate the malfunctioned crawling device, let the crawling device restart. Otherwise, rescue crawling device may carry down the malfunctioned crawling device. Alternatively, the rescue crawling device may charge or replace the battery of the crawling device without power.

As mentioned above, the crawling device may be fixed at high altitudes through a mechanical device without electricity. At the time, rescue crawling device input the power into the malfunctioned crawling device through the end of the conductive temporarily to unlock the crawling device. If the crawling device is still able to move, the crawling device may even take over control and operate the malfunctioned crawling device through the rescue crawling device. In other words, the rescue machine may climb up and pull down the crawling device which is malfunctioned or without power.

Furthermore, the crawling device may also be provided with a controlling rope for conducting additional operations such as failure or exception. For example, the controlling rope may be hung down by remote for the operator to manually guide the crawling device. For example, supply gears and other mechanical construction strength using hand pull to withdraw the mechanical crawling device to the ground successfully.

In addition to simply providing the force and the guide, the controlling rope may also be configured like remote-control switch, for the operator to manually conduct the crawling device in the case of exceptions. For example, when control computer of the crawling device is in abnormal situation, it is able to remote-control this kind switch to manual operation and enable crawling device successfully return to the ground.

The crawling device mentioned above provides movement effectively to a predetermined position relative to the cylinder. But usually in order to play the real function of the crawling device, various different functions of the device may be added. The crawling modules with the functional device move to a predetermined position of the cylinder, and let the functional device function.

For example, a functional device may include a camera for short-term temporary or long-term security photography or other photographic operations, such as holding temporary concert activities in a square, in the community just built, in the Spring Festival transportation area or parade area. Through crawling device mentioned above may quickly deploy and remove multiple cameras, and complete the deployment of the area rapidly.

Furthermore, at the time of implementation, it may be determined by the crawling device at the own discretion or by a remote server, or by means of a manual operation to adjust the height and the angle of the camera relative to the cylinder during the operating process through the computer visual operation and the scheduled rule to capture the required picture.

And, if interacting with another crawling device which has a camera, crawling device may automatically adjust each other at different angle and height of cylinders to achieve and cover the purpose of monitoring or photographing the set scene. This may provide a quick and effective solution for the needs of a wide range and no blind-side photography.

The functional device may also include a mechanical operating device such as a mechanical arm for setting other equipment on the cylinder, such as replacing a street lamp, picking fruit and so on.

The cylinders may have different obstacles. For example, the poles might have wires that extend perpendicularly to the cylinder. Therefore, the drawstring and the crawling module may adjust the design for different obstacles and situations of the cylinders. For example, when the crawling device is fixed in one of the sections, another section may temporarily open the drawstring and pass through a vertical line obstacle such as a wire.

At the beginning of the installation, the initial climbing mode may be set. As long as the operator holds the crawling device to the cylinder, the crawling device may automatically pull the drawstring and adjust the drawstring through the motion sensor and inform the operator whether tension of the drawstring can hold the cylinder and keep the crawling device in a fixed state. In other words, when deploying a crawling device, it is possible to simultaneously test whether the crawling device is malfunctioned and whether the crawling device is suitable for installing on the cylinder, or whether the crawling device is necessary to replace different materials of the drawstring, or replace the crawling modules with different parameters.

In the other embodiment, one of the two or more nodes crawling modules is secondary machine with carrying function. The carrying functional device and the other crawling modules are fixed separately on the predetermined position of the cylinder after the secondary machine moving to the predetermined position. Through the design, the secondary machine may be designed as waterproof, and do not have to configure the battery and other complex mechanical structure.

There are multiple possibilities for the way of the actual production, for example, three crawling modules may be used, where the top section is used to stay on the cylinder. Another possibility is to use two crawling modules, after climbing to the predetermined position of the cylinder, the functional device is hung or fixed at a specific position of the cylinder. After that, the crawling module may leave the cylinder. Another approach may be hanging the rope down to the ground and other ways when the secondary machine reaches a predetermined location. Alternatively, the other crawling modules may be crawled down in the way of two sections when they come down from the cylinder; they may also control the elastic band as a brake, descend with gravity, or use an auxiliary rope to descend.

Besides, the components of the crawling device may implement the modularization design, accord to the need of climbing different obstacles, and configure the different specifications of the components. For instance, it may be specific to different height, distance, surface smoothness of the cylinder and provide a different drawstring, or different pull force of the crawling module, or different battery capacity and so on. For example, in the deployment of the cylinder in Harbin and other region which is easy to freeze, it may be possible to add a heater to solve the unmovable problem because of freezing situation.

The crawling device may set various sensors to collect the state of the operation for the corresponding processing. For example, the crawling device may detect whether sliding through the motion sensor. If there is a slide, the crawling device may tighten the force or provide a warning. In addition, the crawling device may be set buffer device, the crawling device may buffer while falling to avoid the engine body break down or cause passengers to be injured.

According to another embodiment of the invention includes a method of rapidly deploying multiple functional devices in a region, wherein the region has multiple cylinders. Multiple crawling devices are deployed at multiple predetermined heights and angles of the plurality of different cylinders. Each of the crawling devices has a functional device. The functional device has a sensor, the method including: obtaining the information separately from the sensor of the functional device through the communication network, integrating and comparing these information, automatically calculating the relative heights and angles of these crawling devices and the corresponding cylinders, and sending the control signal, controlling and adjusting these crawling devices to the compatibly relative heights and angles.

The implementation of the method may be programmed or stored in one of the crawling devices or multiple crawling devices through a control program or installed on another electronic device to communicate and control with these crawling devices over a communication network, or executed partly by crawling device and partially by an external computer, a server, etc. to achieve the above functions.

The functional device mentioned here may be a camera, the use of security device, or such as a concert video. The functional device mentioned here may be a broadcast speaker for providing short or long term broadcast settings. The functional means may also be light for providing illumination of the area in accordance with the predetermined conditions.

In addition to these functional devices, there may be various other functional devices, which may be considered within the scope of the present invention with the same or similar concepts.

### BRIEF DESCRIPTION OF DRAWINGS

FIG. 1 illustrates the embodiment of the crawling device according to the present invention.

FIG. 2A and FIG. 2B illustrate the diagram of the crawling movement of the crawling device according to the embodiment of the present invention.

FIG. 3A and FIG. 3B illustrate the diagram of the horizontally rotating of the crawling device according to the embodiment of the present invention.

FIG. 4 illustrates the way of rescuing crawling device.

FIG. 5 illustrates the flow chart of the deployment method according to the embodiment of the present invention.

FIG. 6A and FIG. 6B illustrate the different implemented methods.

### DETAILED DESCRIPTION

The following description is a crawling robot embodiment of the inventive crawling device. The following descriptions of technical innovations include the following content.

The climbing robot may hold the innovation design of the device tightly with a flexible tensioning belt to achieve a compact structural and be adaptive to various cylindrical materials characteristics; and have a strong adaptability to different diameters of the rods or columns to make the climbing movement be rapidly and accurately.

The locking way of the climbing robot may employ a mechanical locking device so that the robot may be safely, stably and reliably fixed on the rod or column without sacrificing the power of the robot itself, thereby increasing the continuous working time of the robot.

The use of “linear guide rod” and “ring arc moving technology” may make the climbing robot in the longitudinal direction of the climbing rod and swiveling at round 360° any direction come true.

The solution to the embodiment rescuing problem is that as long as there are at least two climbing robots, it is possible to achieve docking recovery together without designing another rescuing machine.

The embodiment is mainly composed of a climbing robot execution parts, an electromechanical control system, an energy supply system, a signal transmission system and a remote control, and the design consideration while implementation is also included.

In order to realize the self-adjustment control of the robot under different loading conditions, measuring various friction coefficients of different cylindrical materials and carrying out multiple load tests of climbing robot to obtain the experiment are needed to establish the mathematical model data.

Select and match the appropriate rotating electric and linear motors under the satisfying power conditions.

The climbing robot obtain the perception of environmental location and self-diagnosis ability to improve the climbing robot intelligence and the reliability of overall system through the information collected by a variety of sensing and detecting devices, and through the data fusion technology.

By integrating the robot motion perception information and machine vision information realize the motion control of the climbing robot, and provide the rescue climbing robot an effective technical solution for the exact positioning of the rescue interface to the robot which is waiting for rescue.

Through the effective and low-cost wireless remote control operation technology solution of climbing robot may reduce the difficulty of the operator's operation and improve the reliability of the remote-control operation of the climbing robot.

The operation and the flow of the embodiment may be illustrated below.

First of all, with regard to the rapid delivery of climbing robots, the kind of climbing robot is put in a way that makes the flexible tensioning belt of the deployment of the climbing robot to hold the rod or column with a quick snap hook similar to the fast buckle of the car harness. The robot moves quickly to the specified height of the pole in a straight way to complete task of delivery quickly.

Secondly, with regard to the rapid recovery of the climbing robot, when the climbing robot is in normal operation, and climbing robot receives a command to return to the ground, the robot may perform a climbing movement until the device reaches the designated height of the ground, stop the climb movement, and complete the recovery task.

Furthermore, for the rescued recovery of the climbing robot, the climbing robot may not hold the rod or the column tight in the non-movement state without power. Therefore, the climbing movement of the climbing robot must be driven by electric power. When the power consumption of the climbing robot is exhausted or breakdowns, the same type of climbing robot may be used to carry out recovery and rescue in a docked way to improve the overall survivability and maintenance of the climbing robot.

The technical principle of the embodiment may be illustrated below.

Since the length of the flexible tensioning belt is adjustable, the fastening action of the climbing robot is carried out by means of a flexible tensioning belt, which may be adapted to various rods of different diameters, even rods or columns with non-cylindrical cross sections. This improves the adaptability of climbing robots to different diameter climbing rods. Not only that, due to the flexibility of the tensioning belt, the tensioning belt forms a larger surface to contact with the surface of the climbing rod, which increases the friction of the climbing robot, thus improving the carrying capacity of the system.

Besides, the climbing robot may employ a mechanical locking device. For example, the use of self-locking characteristics of the turbine and worm gear. The mechanical locking device may make the robot be safely, stably and reliably fixed on the rod or column without sacrificing the power of the robot, thereby increasing the continuous working time of the robot in the non-movable state.

And, the use of “linear guide rod” and “ring arc moving technology” may make the climbing robot in the longitudinal direction of the climbing rod and swiveling and ascending at round 360° any direction come true. The way of movement may be achieved by swiveling the robot in any direction of 360° when the robot moves to any height.

Furthermore, by using the docking technology it may achieve that as long as there are more than two climbing robots, it is possible to achieve docking recovery together without designing any other rescuing machine.

The hardware solution of the embodiment may be illustrated below. First, the design of the climbing robot fastening device is illustrated below.

The climbing robot may use a rigid clip or a rigid clip with a drive wheel to achieve the fastening function of the climbing robot. The shortcomings of the tightening method include the fact that they may not accommodate larger diameter rods and columns, resulting a wider range of climbing robot applications which is subject to larger restrictions. As a result of the use of rigid card folder, the folder and the cylinder contact area is small. In order to meet the climbing requirements of the friction, because climb the robot clamping force is very large, which often cause climbing rod or column damaged. Most of the climbing robot locking devices need to consume a lot of power, so the continuous working time is short, which is not conducive to the robot for a long time aerial work.

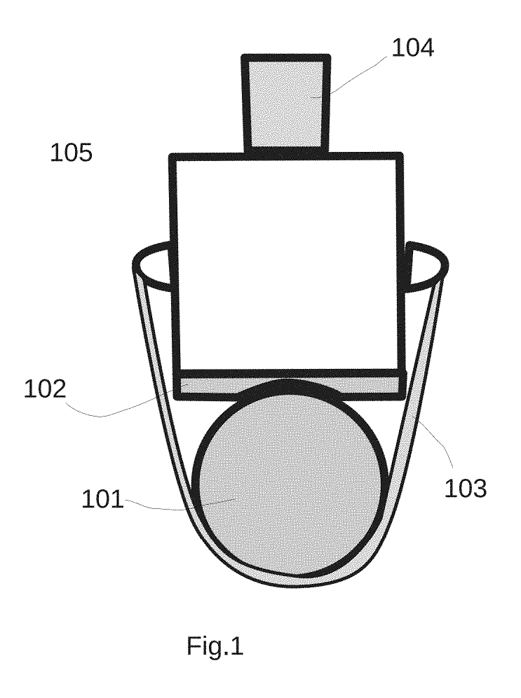

In view of the problems of the climbing robot holding device, the product provides the use of the flexible tensioning belt plus the mechanical locking device to achieve the holding function of climbing robot. Specific program is shown in FIG. 1.

The crawling robot 105 is used to crawl on the post 101. The length of the flexible tensioning belt 103 in the crawling robot 105 is adjustable so that the crawling robot may accommodate a variety of rods with different diameters, even rods or columns of non-cylindrical cross-sections. In addition, the crawling robot 105 has a camera 104 for achieving a photographing function or a computer vision operation. The friction pad 102 serves to increase the friction with the cylinder and increase the stability. This improves the adaptability of climbing robots to different diameter climbing rods Moreover, due to the tension of the flexible feature, the tensioning belt forms a larger surface contacts with the climbing rods. Thus, the pressure of the flexible tensioning belt and the cylinder is reduced, and the tension is replaced by the clamping force during the climbing process of the robot, and plays a better protective effect on the surface of the climbing rod or column. The product is proposed to hold the mechanism by using mechanical locking device, such as the use of self-locking characteristics of the turbine and worm gear, etc., and may achieve that when the motor stops, the mechanism soon be in the locked state. Thus, it greatly improves the safety and reliability of the system, and conserves the power loss of the system.

The following shows the realization of the climbing and moving technology. At present, the movement of climbing robots is mainly in the type of wheel and guide rod. Wheel speed is fast, flexible to control, but hard to maintain a certain degree of static friction on the cylinder, poor barrier capability; guide rod speed is faster, with a certain barrier capability, but may not steering.

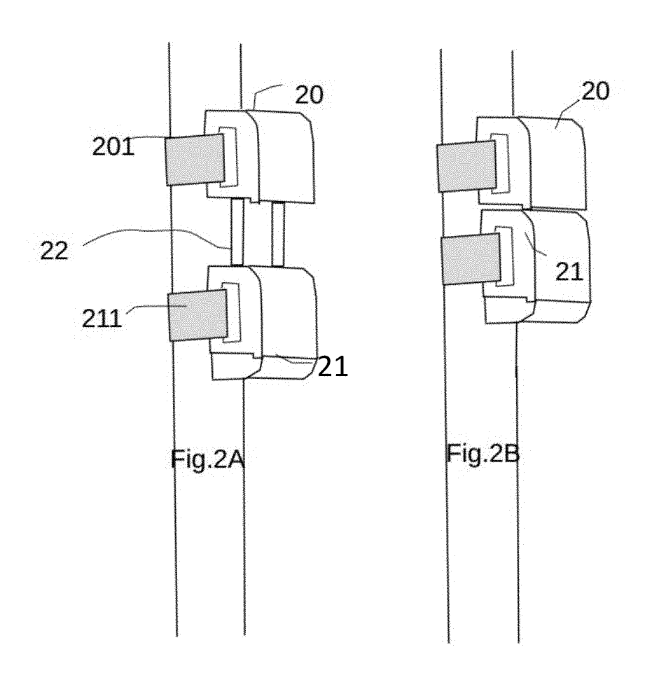

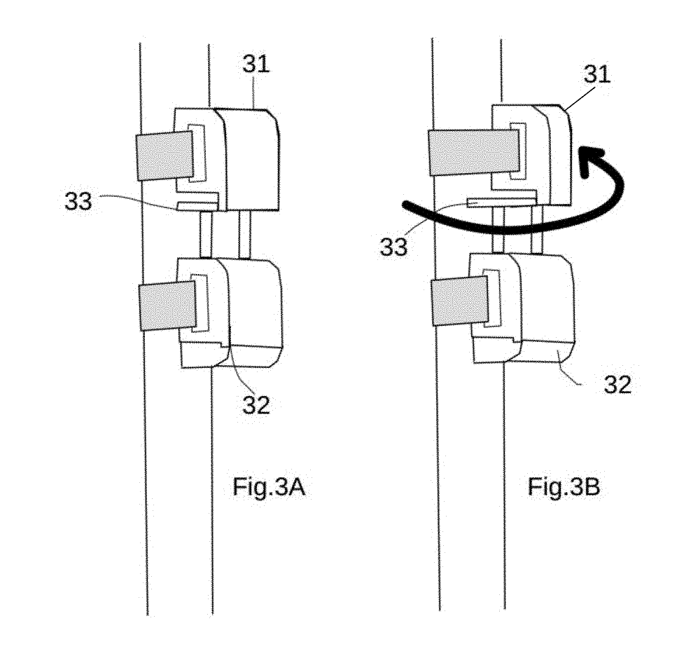

The embodiment of the invention is capable of moving quickly and accurately on a vertical wall to a determined target of the nearby requirement. The product proposes a linear guide rod and a ring arc moving technology to realize a climbing robot in the longitudinal direction of the climbing rod, and swiveling and ascending at round 360° in any direction. The way of movement may be achieved by swiveling the robot in any direction of 360° when the robot moves to any height. Specific programs shown in FIG. 2, FIG. 3.

In the embodiment, the device is mainly driven by the straight screw to the guide rod mechanism to achieve the climbing robot to climb up and down, that is, when the mechanism is climbing upward, the lower body of the mechanism is in the tightened state, the upper body is in the released state and stretch up a certain distance, and then while the upper body in the tightened state, the lower body release and rise a certain distance, and repeated movement again. When the mechanism descends down, the upper body of the mechanism is in the tightened state, the lower body is in the released state and extends downwardly for a certain distance, and then the lower body is in the tighten state, the upper body is released and descends to a certain distance, and repeated movement again. Such a movement may always keep the robot in a tightening state. Thereby the movement can improve the stability and reliability of the system. The loop movement of robot may be achieved when the climbing robot is at a specified height, the lower body of the mechanism in a state of tightening, the upper body in the loose state and moving in the circumferential direction of a certain angle, and then the upper body in the tighten state, the lower body open and follow the upper body in the circumferential direction to move the same angle. This kind of repeated movement may make the climbing robot swivel in any 360° direction at specified height come true.

Then, explain the docking recovery rescue design of climbing robot.

The climbing robot may hold the rod or the column tight in the non-movement state without power. Therefore, the climbing movement of the climbing robot must be driven by electric power. When the power consumption of the climbing robot is exhausted or breakdowns, the product design may use the same type of climbing robot to carry out recovery and rescue in a docked way to improve the overall survivability and maintenance of the climbing robot.

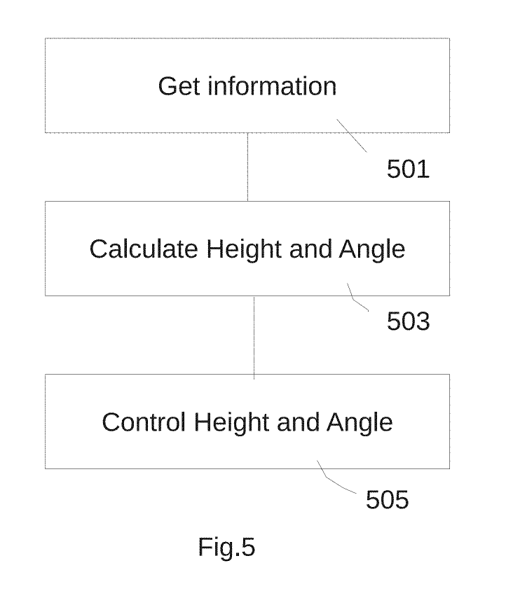

FIG. 5 illustrates the rescue interface of the upper and lower bodies of the robot.

There are three interfaces on the top of upper body of the climbing robot. The two sides are the positive and negative interface of the power interface, and the middle of the control signal interface pin (shown in FIG. 5). There are three interfaces on the bottom of the lower body of the climbing robot, and the power interface on both sides corresponds to the positive and negative pin and socket of the top of the power, and the middle is the control signal socket. When the climbing robot is used as a rescue robot, the camera is turned upwards to visually identification control the direction of the rescue robot movement to achieve the head of the power interface and control interface docking. After the rescue robot and the standby robot docked successfully, the rescue robot may charge the standby robot and get the right to control the movement of the standby robot. The rescue robot may control and release the upper and lower body fastening devices of the standby robot, thus get the standby robot back to the ground safely.

In addition, the embodiment may include a remote control.

The climbing robot equipped with a camera for viewing obstacles on the rod and surface conditions may remote control visually operating host, which includes of an image display screen, remote control lever, control button, for controlling, observing and recording the operating situation of the equipment. Operations of the host function have, displaying the obstacles on the rod, the surface of the situation video, viewing the climbing robot state, controlling the climbing robot remotely.

Remote control with panel integrated design, 8-inch LCD display, with 16-channel remote control device may be freely assigned channel for the device motion control, camera cradle head control, and automatic, controlled and power-saving mode conversion. Remote control may visually display the system voltage and equipment timing, and may alarm with low power and breakdown.

The following description is provided for the technicians who is skilled in technical field, but is not used for limiting the scope of the invention.

The complete system of climbing robots may include: a set of climbing robots and rescue robots, each containing executive parts, electromechanical control systems, energy supply systems, and signal transmission systems and a set of remote control.

In a particular embodiment, the horizontal rotation direction of the climbing robot is 360°; the net weight of the actuator of the climbing robot (excluding the battery) is less than or equal to four kilograms. Net load weight of the climbing robot is more than ten kilograms, installing twelve voltages, and eighty AH, the large capacity battery after the net load weight is five kilograms. The climbing height of the climbing robot is not less than a hundred meters. The climbing robot provides a standard camera installation interface and bracket. The distance of climbing robot wireless remote control is not less than one hundred and fifty meters. Climbing robot wireless transmission rate is more than twenty Mbps. Remote control 8-inch LCD display, 16-channel remote control.

The embodiments of the invention are illustrated below referring to the figures.

Referring to FIG. 1, FIG. 1 is a top view of one of the crawling modules from the embodiments of the crawling devices.

The crawling module 105 carries the functional device 104, such as a camera and the corresponding power circuit. The crawling device is used for surrounding a cylinder 101 and crawling along the extension direction of the mentioned cylinder 101. The kind of crawling device may include at least two-nodes crawling modules 105, a telescopic mechanism, and a control circuit.

The telescopic mechanism connects with two-nodes crawling modules, and the crawling modules have an elastic mechanism and a drawstring 103 respectively. In the example of FIG. 1, crawling module has an elastic sheet 102 at the direction close to the cylinder 101 to increase the friction.

Please refer to FIG. 2A and FIG. 2B. FIG. 2A and FIG. 2B illustrates the embodiment of the two-node crawling module, and the example of the crawling movement. In the example of the crawling device in the FIG. 2A and FIG. 2B, the crawling device includes the crawling module 20 and the crawling module 21. In the creeping movement, at least two-nodes crawling modules 20, 21 are set in turn that one crawling module as a fixed section and the other crawling module as a mobile section. Crawling module 20 connects with crawling module 21 through the telescopic mechanism 22.

When the crawling module 20 or the crawling module 21 is set as a fixed section, the crawling module 20 or the crawling module 21 adjust the drawstring 201, 211 through the elastic mechanism to make the fixed section close to the cylinder. Producing friction by keeping close to the cylinder let the fixed section maintain the fixed state relatively close to the cylinder.

When the crawling module is set as a mobile section, through the elastic mechanism it adjust the drawstring 201, 211 making the mobile section separate from the fixed state. And through the telescopic mechanism 22, the crawling module adjust the relative position of the mobile and fixed section making the crawling device perform crawling movement.

Through FIG. 1 and FIG. 2A and FIG. 2B, a person who is familiar with the field of mechanical design may know that through the bearings in the figures with the corresponding motor and other electrical and mechanical structure may achieve the required telescopic structure. Of course, to make the drawstring produce the power of contraction, the actual production may be completed through the corresponding motor or gear and other structures. Since these are known to those skilled technicians and have multiple alternatives to choose, they may not be illustrated in details.

Please refer to FIG. 3A and FIG. 3B. In addition to providing vertical movement, in another embodiment, the crawling device may also be installed with a horizontal rotation mechanism 33 for connecting with the two-nodes crawling modules 31, 32.

Through the horizontal rotation mechanism 33 and the two-nodes crawling modules 31, 32 adjust the relative angle relative to the cylinder. For example, when one crawling device is fixed section and the other is mobile section, the movable section is rotated horizontally around the cylinder through the horizontal rotation mechanism 33. Besides, the two crawling modules 31, 32 are capable to be the fixed section and the mobile section alternately. Also, the crawling device may be positioned relative to the cylinder at any angle of 360° through multiple horizontally rotating. Of course, this is only a case of the embodiment, depending on different technical requirements, such as the construction of the cylinder, the surface friction, the obstacle, the purpose of setting the crawling device, the weight of the carrying object, whether take the set angle into account, or cost considerations, etc., the designer may adjust the different configurations to achieve the purpose. All of these may still be considered to be within the scope of the invention, but not limited by the embodiments provided below.

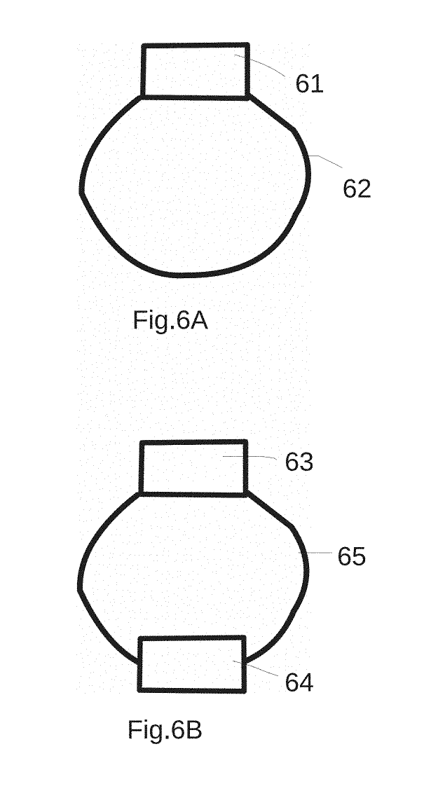

Referring to FIGS. 6A and 6B, two different embodiments are shown separately. In FIG. 6A, the crawling module is constituted by the mechanical module 61 and the drawstring 62, forming a surrounding structure for holding the corresponding cylinder. FIG. 6B is shown by two mechanical modules 63, 64 and a drawstring 65. In other words, more variation of the extensions is within the scope of the present invention.

Moreover, about the functional setting of two or more crawling modules, these crawling modules are capable of being constructed in the same way and connected with each other through the telescopic mechanism.

On the other hand, these crawling modules may also be set as one of the secondary machines that are equipped with a functional device (such as a camera), the other one or more crawling modules are set as primary machines. The secondary machine is fixed to the cylinder after reaching the predetermined position and is disengaged from the primary machine. The primary machine using slow descent or secondary machine hanging rope in other ways to get down, then using the same way to get up. Or, the primary machine may also design two-nodes crawling module. In this way, the secondary may be powered by the primary machine during the crawling process and fixed at the specified location to execute the task. In other words, the secondary machine may be simplified as much as possible to lower manufacturing costs, and the same primary machine may be used to deploy multiple secondary machines. The primary machine may also depend on cost considerations and do not need to have a complex waterproof or durable design for long-term use in bad weather. The design is like a lunar module and the propellant rocket, may further enhance the overall crawling device technology and function.

For a crawling device, the crawling device is capable of having two or more crawling modules. The following detailed implementation and the accompanying illustration may further illustrate the example.

Furthermore, the cylinders are able to be telephone pole, street pillar, the columns of buildings or bridges and so on. Since the crawling device is used to adjust the circumference of encircled drawstring, so in a variety of tubular, rod, cable and other different cross-sectional shape, perimeter and material, cylinder may use the same crawling device to crawl and deploy. Alternatively, the configuration of the crawling device may be adjusted through replacing the drawstring and other modularization way to be in response to various needs of crawling deployment.

The cylinders may be tubular, solid and having a single cross-sectional perimeter shape, such as cylindrical column, elliptical column, square column, polygon column, or different cross sectional shape at different sections. The cylinders may be the up and straight column type of the electric pole, or a square cylinder, or column extension, and the extension direction may be straight or non-linear. The column may be artificial or natural, such as trees or artificial stents.

The drawstring may be resilient or non-elastic. For example, drawstring may be soft material which is able to coil. Holding the drawstring open and bypassing the obstructions on the cylinder while the mobile device is moving which also include an open structure. The crawling module corresponds to one or two more of the drawstrings, which are made of multiple connecting blocks similar to metal brackets, or made of plastic, rubber, cloth, textile, and so on. If the cylinder has a preset track, bump or groove, the cylinder is capable of configuring the corresponding drawstring.

Besides, the drawstring close to the side of the cylinder may additionally increase the surface which increases friction, such as bumps, particles, streaks or grooves.

With the different extension directions of the cylinder, the crawling device is capable to move up and down, but actually to move horizontally, also to diagonally move, even to annular movement.

The control circuit and the corresponding control function may be set all or one part inside of the crawling device. One part of the function may be set outside of the crawling device. For example, part of control function is controlled by the external device or in cooperation with the other crawling device or other external devices, or manually control, or switching between multiple control modes in accordance with predetermined conditions.

In addition, the control circuit may be a module, mainly installed in a crawling module, also each crawling module may have a related circuit, and these circuits work together.

The control circuit may have computer vision operation to detect obstacles on the cylinder. The computer vision operation may compare crisscross or analyze the still images of the moving process to find the size and shape of the obstructions and accordingly determine the way to bypass the obstructions, and accordingly determine the way to bypass the obstructions. The computer vision operation here may include various known computer vision identification software and/or hardware integration, such as all kinds of computer vision identification software or hardware in the use of unmanned vehicles. In addition, the computer vision operation here also may include a variety machine learning, such as using Support Vector Machine, Fuzzy Logic, neural network learning. Deep Learning, etc., to record and identify various obstacles on the cylinder through the feedback or non-feedback learning way. These areas and related technologies are able to be all integrated into the crawling device and are well known by those technicians of computer vision and machine learning. The concept may not be mentioned in details. Moreover, since the environment of the crawling cylinder is relatively simple, for instance, the images of the cylinder of each angle may be photographed in advance, and the comparation of the images in the process of the crawling device moving forward may help quickly determine the shape and size of the obstacles, and bypass or cross the obstacles according to the predetermined logic.

The crawling device may attach a camera. The camera may be connected with the control circuit of the crawling device. Otherwise, the camera may be a module to move to a predetermined position relative to the cylinder only through the carry of the crawling device. Alternatively, the camera may be powered by the crawling module.

The crawling device may be equipped with a battery to achieve a certain degree of mobility. Furthermore, the crawling device is also powered by the power supply circuit inside the cylinder after crawling to the proper position. Alternatively, the crawling device may set the operation mode for different power according to the internal battery power. For example, in order to let the staff replace the battery or charge operation easier, the crawling device, which has been fixed to the top of the cylinder like pole, may automatically crawl to another location with a charging end height in advance, or automatically crawl to the bottom.

If the camera is installed, the camera may make crawling device in accordance with the images shoot whether the crawling has reached the predetermined position or not through the hardware or software settings. For example, the crawling device is capable of placing a reference image of a predetermined size on the ground in advance, letting the camera shoot and convert, and then determining the altitude at that time. Moreover, a reference image of a predetermined size may be placed on the ground with the same technique. Depending on the calculation of the test image size and angle placed on the target location of the shooting, the crawling device may adjust and control the crawling device, make the crawling device to reach the appropriate location through the easy identification. The approach may be quickly deployed and aimed on the height and angle of the camera, rather than through the complex manual computation or operation.

In addition to analyzing the image through the camera, crawling device may also automatically detect whether the crawling device has been crawled to the height and fixed at the set height by means of a height sensor or calculating crawled distance, for example, methods like calculating the number of turns through the wheel of the cylinder.

With respect to the angle, the crawling device may automatically adjust the angle of the crawling device by the direction detection sensor such as a compass. There are various directions of electronic or mechanical or micromechanical way that may be used to detect angles.

Besides, the crawling device may also set GPS and other positioning circuit. The control circuit may be based on the location of GPS, with reference to a previous specific height and angle of GPS location, and the operational model, to set the crawling device. The design method, for a large number of deployments of multiple crawling devices to a different location of one area, may have a lot of convenience. The operator only needs to carry multiple and identical crawling devices to a different position, and then let these crawling devices began to climb the corresponding poles and other columns. These crawling devices may accord with the predetermined parameters automatically to set up, and further work together. In other words, these crawling devices may form a crawling device network through the internet or other means to complete a complex job together.

The applications of multiple machines work and complete together, sometimes devices other than the crawling device, such as some devices that are set on the ground or in certain fixed positions, are required. These devices may complete the work together via Bluetooth, Wi-Fi, 3G, 4G, 5G, Z-Wave. and other wired or wireless communication networks. Related operations may refer to the Internet of things and the relevant network programming concepts, and design for different applications. The concepts may not be mentioned here in details.

In addition, in order to conserve power consumption, when the crawling device climbs to the predetermined position, the crawling device may lock the structure through the mechanic without using electric power to remain fixed in the relative position of cylinder. For example, the crawling device is capable of using the gear and other structures to tighten the drawstring through the power. The gear mechanical structure can maintain the state at that time in the absence of power. If moving the crawling mobile device is needed, then apply power, and then drive the gear to adjust the drawstring, such as relaxation or tension, and conduct the corresponding moving operation.

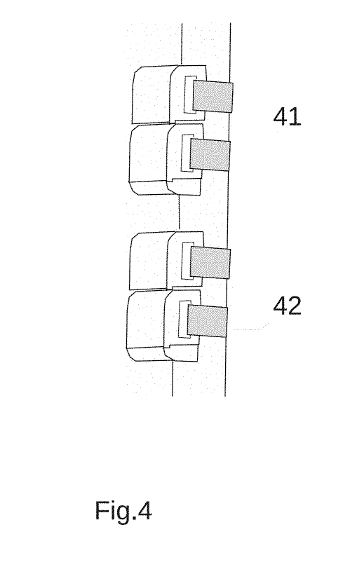

Please refer to FIG. 4. If the crawling device breaks down or loses power in high altitude. At the time, according to the situation, cast another crawling device 42, crawling next to the malfunction or loss of the crawling device 41. Then, the rescue crawling device 42 may be used for replacing and other repairing operations for the defective crawling device 41. Sometimes, if only because of software, rescue crawling device 42 may also operate the malfunctioned crawling device 41, let the crawling device 41 restart. Or rescue crawling device 42 may carry down the malfunctioned crawling device 42. Alternatively, the rescue crawling device 42 may charge or replace the battery of the crawling device 41 without power.

As mentioned above, the crawling device may be fixed at high altitudes through a mechanical device without electricity. At the time, rescue crawling device input the power into the malfunctioned crawling device through the end of the conductive temporarily to unlock the crawling device. If the crawling device is still able to move, the crawling device may even take over control and operate the malfunctioned crawling device through the rescue crawling device. In other words, the rescue machine may climb up and pull down the crawling device which is malfunctioned or without power.

Furthermore, the crawling device may also be provided with a controlling rope for conducting additional operations such as failure or exception. For example, the controlling rope may be hung down by remote for the operator to manually guide the crawling device. For example, supply gears and other mechanical construction strength using hand pull to withdraw the mechanical crawling device to the ground successfully.

In addition to simply providing the force and the guide, the controlling rope may also be configured like remote-control switch, for the operator to manually conduct the crawling device in the case of exceptions. For example, when control computer of the crawling device is in abnormal situation, it is able to remote-control this kind switch to manual operation and enable crawling device successfully return to the ground.

The crawling device illustrated above provides movement effectively to a predetermined position relative to the cylinder. But usually in order to play the real function of the crawling device, various different functions of the device may be added. The crawling modules with the functional device move to a predetermined position of the cylinder, and let the functional device function.

For example, a functional device may include a camera for short-term temporary or long-term security photography or other photographic operations, such as holding temporary concert activities in a square, in the community just built, in the Spring Festival transportation area, parade area. Through crawling device mentioned above may quickly deploy and remove multiple cameras, and complete the deployment of the area rapidly.

Furthermore, at the time of implementation, it may be determined by the crawling device at the own discretion or by a remote server, or by means of a manual operation to adjust the height and the angle of the camera relative to the cylinder during the operating process through the computer visual operation and the scheduled rule to capture the required picture.

And, if interacting with another crawling device which has a camera, crawling device may automatically adjust each other at different angle and height of cylinders to achieve and cover the purpose of monitoring or photographing the set scene. This may provide a quick and effective solution for the needs of a wide range and no blind-side photography.

The functional device may also include a mechanical operating device such as a mechanical arm for setting other equipment on the cylinder, such as replacing a street lamp, picking fruit and so on.

The cylinders may have different obstacles. For example, the poles might have wires that extend perpendicularly to the cylinder. Therefore, the drawstring and the crawling module may adjust the design for different obstacles and situations of the cylinders. For example, when the crawling device is fixed in one of the sections, another section may temporarily open the drawstring and pass through a vertical line obstacle such as a wire.

At the beginning of the installation, the initial climbing mode may be set. As long as the operator holds the crawling device to the cylinder, the crawling device may automatically pull the drawstring and adjust the drawstring through the motion sensor and inform the operator whether tension of the drawstring can hold the cylinder and keep the crawling device a fixed state. In other words, when deploying a crawling device, it is possible to simultaneously test whether the crawling device is malfunctioned and whether the crawling device is suitable for installing on the cylinder, or whether it is necessary to replace different materials of the drawstring, or replace the crawling modules with different parameters.

In the other embodiment, one of the two or more nodes crawling modules is secondary machine with carrying function. The carrying functional device and the other crawling modules are fixed separately on the predetermined position of the cylinder after the secondary machine moving to the predetermined position. Through the design, the secondary machine may be waterproof design, and do not have to configure the battery and other complex mechanical structure.

There are multiple possibilities for the way of the actual production, for example, three crawling modules may be used, where the top section is used to stay on the cylinder. Another possibility is to use two crawling modules, after climbing to the predetermined position of the cylinder, the functional device is hung or fixed at a specific position of the cylinder. After that, the crawling module may leave the cylinder. Another approach may be hanging the rope down to the ground and other ways when the secondary machine reaches a predetermined location. Alternatively, the other crawling modules may be crawled down in the way of two sections when they come down from the cylinder; they may also control the elastic band as a brake, descend with gravity, or use an auxiliary rope to descend.

Besides, the components of the crawling device may implement the modularization design, accord to the need of climbing different obstacles, and configure the different specifications of the components. For instance, it may be specific to different height, distance, surface smoothness of the cylinder and provide a different drawstring or different pull force of the crawling module, or different battery capacity and so on. For example, in the deployment of the cylinder in Harbin and another region which is easy to freeze, it may be possible to add a heater to solve the unmovable problem because of freezing situation.

The crawling device may set various sensors to collect the state of the operation for the corresponding processing. For example, the crawling device may detect whether sliding through the motion sensor. If there is a slide, the crawling device may tighten the force or provide a warning. In addition, the crawling device may be set buffer device, the crawling device may buffer while falling to avoid the engine body breakdown or cause passengers to be injured.

Please refer to FIG. 5, showing the flowchart of the embodiment. According to another embodiment of the invention includes a method of rapidly deploying multiple functional devices in a region, wherein the region has multiple cylinders. Multiple crawling devices are deployed at multiple predetermined heights and angles of the plurality of different cylinders. Each of the crawling devices has a functional device. The functional device has a sensor, the method including: obtaining the information separately from the sensor of the functional device through the communication network (Step 501), integrating and comparing these information, automatically calculating the relative heights and angles of these crawling devices and the corresponding cylinders (Step 503), and sending the control signal, controlling and adjusting these crawling devices to the compatibly relative heights and angles (Step 505).

The implementation of the method may be programmed or stored in one of the crawling devices or multiple crawling devices through a control program or be installed on another electronic device to communicate and control with these crawling devices over a communication network, or executed partly by crawling device and partially by an external computer, a server, etc. to achieve the above functions.

The functional device mentioned here may be a camera, the use of security device, or such as a concert video. The functional device mentioned here may be a broadcast speaker for providing short or long term broadcast settings. The functional means may also be light for providing illumination of the area in accordance with the predetermined conditions.

In addition to these functional devices, there may be various in other functional devices, which may be considered within the scope of the present invention with the same or similar concepts. As long as the variations are covered within the scope of the invention may be included in the scope of the invention.

1. A crawling device for surrounding a cylinder and crawling along an extension direction of the cylinder comprising:
at least two-nodes crawling modules,
and a telescopic mechanism, wherein the telescopic mechanism connects with the at least two-nodes crawling modules, and crawling modules have an elastic mechanism and a drawstring;
in creeping movement, wherein the at least two-nodes crawling modules set one crawling module as a fixed section and set the other crawling module as a mobile section in turn;
the time the crawling module being set as the fixed section, wherein the crawling module adjusts the drawstring through the elastic mechanism to make the fixed section close to the cylinder, and produce friction by keeping close to the cylinder to make the fixed section keep a fixed state relatively close to the cylinder;
the time the crawling module being set as the mobile section, wherein the crawling module adjusts the drawstring through the elastic mechanism to make the mobile section separate from the fixed state, and the crawling module adjusts a relative position of the mobile section and the fixed section through the telescopic mechanism to make the crawling device perform crawling movement.

2. The crawling device of claim 1, further comprising a horizontal rotation mechanism for connecting with the two-nodes crawling modules, wherein the two-nodes crawling modules adjust a relative angle of a relative cylinder through the horizontal rotation mechanism.

3. The crawling device of claim 2, wherein the one crawling module is set as the fixed section and the other crawling module is set as the mobile section, wherein the mobile section is rotated horizontally around the cylinder through the horizontal rotation mechanism, wherein the two crawling modules are the fixed section and the mobile section alternately, wherein the crawling device is positioned relatively to the cylinder at any angle of 360 degrees.

4. The crawling device of claim 1, wherein the two crawling modules are constructed in the same way and connected with each other through the telescopic mechanism.

5. The crawling device of claim 1, wherein one of the at least two-nodes crawling modules is set as a secondary machine with carrying function, wherein the carrying functional device and the other crawling modules are fixed separately on a predetermined position of the cylinder after the secondary machine moving to the predetermined position.

6. The crawling device of claim 1, wherein the cylinders are a telephone pole, a street pillar, columns of buildings or bridges, the cylinders are tubular and solid, the cylinders have a cylindrical column, an elliptical column, a square column and a polygon single cross sectional perimeter shape, or a different cross sectional shape at a different section, the extension direction of the cylinder is vertical and straight-lined extension, horizontal direction extension or curve direction extension.

7. The crawling device of claim 1, wherein the drawstring and bending material with a characteristic elastic or non-elastic.

8. The crawling device of claim 1, wherein the crawling module corresponds to one or more drawstrings made of a plurality of connecting blocks being similar to metal brackets, or made of plastic, rubber, cloth, textile and so on.

9. The crawling device of claim 1, wherein the drawstring closes to a side of the cylinder and additionally a surface with increasing friction.

10. The crawling device of claim 1, wherein the crawling device moves up and down, horizontally, diagonally, curvedly or annularly with different extension directions of the cylinder.

11. The crawling device of claim 1, further comprising a control circuit for controlling the crawling module, the telescopic mechanism and the elastic mechanism making the crawling device move in the predetermined way.

12. The crawling device of claim 11, wherein a control circuit has computer vision operation to detect obstacles on the cylinder.

13. The crawling device of claim 11, wherein the control circuit has a camera to analyze a shooting screen of a camera and judge whether the crawling has reached the predetermined position or not.

14. The crawling device of claim 11, wherein the control circuit automatically moves the mobile device to the predetermined position of the cylinder by a height sensor or crawling distance calculation.

15. The crawling device of claim 11, wherein the control circuit automatically adjusts an angle of the crawling device being relative to the cylinder to achieve a predetermined deployment angle through a direction sensor.

16. The crawling device of claim 1, wherein the crawling module retracts the strap by a mechanical locking structure to maintain the relative position of the crawling module to the cylinder without additional power.

17. The crawling device of claim 1, further comprising a rescue interface, and providing another mobile device for coming close to rescue when power is exhausted or failure.

18. The crawling device of claim 1, further comprising the controlling rope being hanged down to operate the mobile device when the mobile device is set in a place where an operator does not directly touch.

19. The crawling device of claim 1, further comprising an additional functional device, the crawling modules with the functional device moving to the predetermined position of the cylinder, and letting the functional device execute the function.

20. The crawling device of claim 19, wherein the functional device comprises a camera for shooting a region at the predetermined position of the cylinder.

21. The crawling device of claim 20, wherein the crawling module adjusts a height and an angle of the camera being relative to the cylinder during the crawling process through computer visual operation to capture a required picture.

22. The crawling device of claim 20, wherein the crawling device transmits information to the other crawling devices with cameras, and automatically adjusts the angle and the height of each other in the different cylinders to commonly cover a range of setting scenes.

23. The crawling device of claim 19, wherein the functional device comprises a machine operating device for performing a mechanical operation when the crawling device is crawling to the cylinder.

24. The crawling device of claim 1, wherein the fixed section is fixed, and the other crawling module temporarily unties a surrounding state with the drawstring around of the cylinder to bypass an obstruction on the cylinder.

25. The crawling device of claim 1, wherein one of the crawling modules is fixed at a predetermined height of the cylinder after reaching the predetermined height of the cylinder, and is disengaged from the other crawling modules.

26. The crawling device of claim 1, wherein the drawstring of the crawling module is detachable, and installs the different drawstring depending on the different cylinders and purposes.

27. The crawling device of claim 1, further comprising a motion sensor for helping determine and control whether to increase pull force of the drawstring around the cylinder.

28. A method of rapidly deploying a plurality of functional devices in a region, the region having a plurality of cylinders, the plurality of crawling devices being deployed at a plurality of predetermined heights and angles of the plurality of different cylinders, part of the crawling device having a functional device, the functional device having a sensor, the method comprising: obtaining information separately from a sensor of the functional device through a communication network; integrating and comparing the information, automatically calculating the relative heights and angles of the crawling devices and corresponding cylinders; and sending the control signal, respectively controlling and adjusting the crawling devices to the compatibly relative heights and angles of the plurality of corresponding cylinders in order to achieve a deployment target.

29. The method of claim 28, wherein the functional device is a camera used for security.

30. The method of claim 28, wherein the functional device is a broadcasting speaker and for advertising.

31. The method of claim 28, wherein the functional device is a lamp and is used to provide area lighting or lighting effects.
